(19) United States
(12) Patent Application Publication
(10) Pub. No.: US 2007/0048710 A1
(43) Pub. Date: Mar. 1, 2007

(54) Bioterrorism and disaster response system

(75) Inventor: Linda Olson, Grand Forks, ND (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: The University of North Dakota, Grand Forks, ND (US)

(21) Appl. No.: 11/501,680

(22) Filed: Aug. 9, 2006

Related U.S. Application Data
(60) Provisional application No. 60/706,636, filed on Aug. 9, 2005.

(51) Int. Cl. G09B 13/02; G09B 23/28

(52) U.S. Cl. 434/262; 434/232

(57) ABSTRACT

Although there is a universal need for training in handling casualties of weapons of mass destruction, a major challenge for delivering such training include the lack of time for over-taxed healthcare professionals and public health personnel to participate. Many of our workforce members work on part-time basis, evening and weekends at other jobs to make ends meet. The availability of courses that meet the needs of our area, limited computer access (either at the workplace or in the homes of our targeted audience) and funding for travel across long distances to attend training are our most serious barriers to carrying out the project. These problems are addressed by offering a multi-platform approach to training, to include a standardized curricula that is available in formats most likely to be used by the trainee (i.e. web-based), a method to evaluate the knowledge learned, and an on-site training scenario to gain experience on how to respond to both just-in-time and real-time disaster situations.

### CROSS-REFERENCE TO RELATED APPLICATION(S)

This application claims benefit of provisional patent application 60/706,636 filed Aug. 9, 2005, which is incorporated by reference.

### BACKGROUND OF THE INVENTION

Rural public health infrastructures tend to have less capacity and resources than their urban counterparts. Hospitals are the nucleus of health planning, activities and resources in our states. However, national policy changes have forced hospitals to downsize bed capacity, and therefore workforce potential. A bioterrorist act or mass casualty incident would increase morbidity and mortality because of our vulnerability and capacity to respond. Our states are facing budget challenges resulting from shrinking tax bases, which have diverted attention from public health preparedness activities to other financial solvency issues. Emergency preparedness training often gets overlooked in light of other shortfalls. It is estimated that the majority of healthcare professionals and public health, civic and other volunteer personnel are inadequately prepared to respond to significant mass casualty incidents.

### BRIEF SUMMARY OF THE INVENTION

The present invention is an educational system that provides a real, time dynamic and continuous education program designed to improve the individual and collective ability of healthcare professionals and public health personnel to prepare for and respond to acts of bioterrorism and mass casualty disasters. The educational system enhances existing continuing education and training programs designed to educate individuals about issues related to public health emergencies resulting from acts of bioterrorism and other disasters, and better prepares them to deal with the consequences rapidly, collaboratively, and effectively in increasingly diverse populations and geographic areas. When used in cooperation with local and state agencies, the system allows for a sophisticated public health infrastructure to deliver an integrated, multi-tiered array of on-line and on-site learning opportunities designed to strengthen the preparedness of the nation's health professionals to recognize, report, and respond to potential threats and disasters.

In a representative embodiment, individuals participate in web-based distance learning instruction coupled with community-oriented training events and web case presentations that promote the multidisciplinary model of health care training.

### BRIEF DESCRIPTION OF THE DRAWINGS

FIG. 1 is a block diagram illustrating components of the educational system.

FIG. 2 is a flow chart illustrating a lesson development process.

### DETAILED DESCRIPTION

The educational system is a continuing education program designed to improve the individual and collective ability of healthcare professionals and public health personnel to prepare for and respond to acts of bioterrorism and mass casualty disasters. Unlike other systems such as one provided by FEMA to provide ready response command training, the present invention is designed as an interactive learning management system to educate individuals about issues related to public health emergencies resulting from acts of bioterrorism and other disasters, and to better prepare them to deal with the consequences rapidly, collaboratively, and effectively in increasingly diverse populations and geographic areas.

The system (1) enhances and builds linkages between the academic institutions and entities that provide bioterrorism and disaster preparedness training; (2) improves and strengthens the current curricula to address the national domestic all-hazards goal in collaboration with CDC, and HRSA Hospital Preparedness and Division of Emergency Management officers; (3) delivers cost and time-effective education and training to a group that includes, but is not limited to healthcare professionals, public health personnel, law enforcement, fire, military, emergency, and any other individual requiring emergency training via a web-site, on-site training, mobile device and other educational delivery modes; (4) enhances the amount of relevant curricular research and development concerning training on bioterrorism or natural or man-made disaster preparedness; and (5) provides real time training in the event of new and adverse situations. The interactive learning management system is capable of a large number and diverse type of participants, including workforce serving vulnerable populations such as geriatrics and pediatrics, Native Americans, and other disadvantaged populations; and expands usage regionally, nationally and internationally.

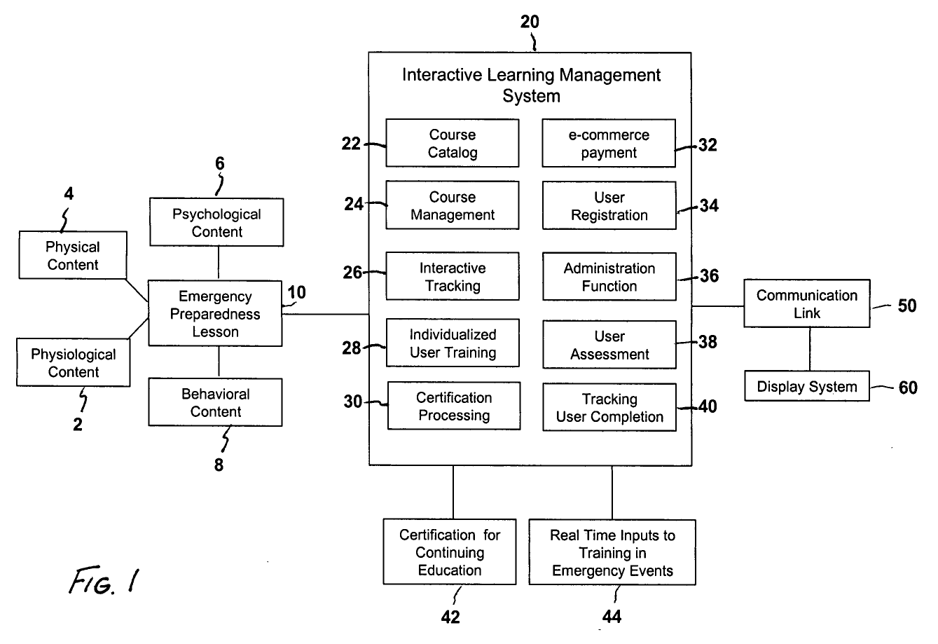

FIG. 1 is a schematic diagram of a bioterrorism and disaster response system that has been developed and referred to as BORDERS (Biochemical Organic Radioactive Disaster Educational Response System). As viewed in FIG. 1, the BORDERS system comprises an emergency preparedness lesson 10, an interactive learning management system 20, a communication link 50, and a display system 60.

An emergency preparedness lesson 10 is prepared and loaded onto the interactive learning management system platform 20. Emergency prepared lessons are prepared from one or more content categories that are critical for front line responders to an emergency situation that is caused by biological, chemical, radiological, environmental, or other disasters that may be man-made or natural in origin. Emergency categories include, but are not limited to, psychological 2, physical 4, physiological 6, and behavioral 8. Emergency preparedness lessons may be based on one or more categories. Examples of the physical 4 content area are those that are caused by radiological, biological, chemical and environmental exposures. An example of radiological disaster is radiation sickness caused by a “dirty bomb”. For a biological disaster, an example is a disease caused by a highly pathogenic infectious agent such as smallpox and avian influenza. In yet another example, a chemical exposure to a deadly gas, such as sarin, may cause rapid illness and death in a defined area of exposure. In still another example, the category of environmental content includes an environmental exposure to earthquakes, floods, tornados, hurricanes, fires and like disasters. For physiological 6 content categories include the response that includes the mechanical, functional and biochemical responses by an organism to exposure to a physical emergency. Behavioral 8 content categories include actions or reactions of a person or animal in response to external or internal stimuli. Content within psychological 2 categories include responses arising from the mind or emotions in response to physical, physiological, and behavioral.

In a representative embodiment, users participate in web-based distance learning instruction coupled with community-oriented training events and web cast presentations that promote the multidisciplinary model of health care training. The interactive learning management system uses proven methods to train users to provide immediate and appropriate responses in the event of bioterrorism or other disasters. It is a “borderless” system whereby students, practitioners, emergency preparedness and disaster management individuals as well as the general public have access to the system's website that allows them to tailor learning programs to fit their needs. The system includes modules for bioterrorism training illustrated by specific case studies and reinforced through a meta-curricular approach.

The interactive learning management system 20 is a dynamic, real time electronic tool. The education and training environment is built on a learning management system infrastructure, including electronic administrative tools. The custom-built learner management system structures the online learning environment by managing, delivering, and tracking learning and offerings to a user or group of users in individual, group, and collaborative learning modes. The interactive learning management systems integrates with other components of the organization such as certification for Continuing Education 42 so administrative and advisory tasks can be streamlined and automated and the overall outcomes of the curriculum can be tracked and quantified.

Interactive learning management system provides support for the course catalog 22; managing courses created from a variety of sources 24; interactive tracking 26 relationships among entities of users, administrators, courses, and schedules; individualized user training 28; generating continuing education management reports for certification 30 on user and course activity; registering and recording user data 34; e-commerce payment and function 32: automating the administration 36 of training events such as scheduling classrooms; electronically assessing and scoring the user for self, pre and post course learning 38; tracking and reporting user activity and achievement 40; storing and managing access to user and course records. The system supports authoring tools and provides consistent look and feel of learning materials. The interactive learning management system provides for one or more of the support parameters.

The technical specifications for the custom-built interactive learning management include, but are limited to Window and Macintosh based browsers using allowed settings such active scripting, scriptiong of Java programs, JavaScript enabled, non-encrypted form data, navigation of sub-frames across different domains, file download and load applications and files in IFRAME. Development languages of utility include HTML, Flash, Cascading Style Sheets, DHTML, and JavaScript.

The custom-built interactive learning management system is SCORM-compliant, allows for real time inputs to training, and has the capacity to be adapted to a variety of display systems 60. Preferred display systems allows real time adjustments 44 to instructional presentations or broadcast and support the integration of various video, audio, graphics, text, and programs without regard to their data format which enables instructors to electronically present instructional materials from in automated classrooms.

The curriculum is based on the principles of problem-based learning currently being used by medical students across the nation. This method puts even the distance-learner at the center of an active learning process, and the systemic modules (instructional resources, technology, and so forth) are prepared or aligned to support the learner. The web-based lessons provide a standard set of learning activities and questions for all participants. Additionally, discipline-specific resources pertaining to each topic are linked to the learning modules. The learner is expected to direct him/herself to those links. This process encourages self-directed learning on the part of the student/practitioner.

As a supplement to the interactive learning management system, live exercises or hands-on training can be provided.

The program's modules and courses may be taken for graduate-level credit, for Continuing Medical Education credit, or for a specialized certificate of completion. The complete modules are available via the system's interactive computer network to a national network of health professions and/or other interested faculty to be used as a curricular tool.

Portions of the on-site training directs students toward hands-on problem solving to real-world challenges, with community-based experiences designed to depict actual biochemical, organic, radioactive, natural or man-made disasters. Because the training provides participants with standardized knowledge regarding bioterrorism across all disciplines, they are better prepared to interact with local, state and federal agencies during times of disaster in a cohesive and organized fashion. Activities are incorporated into the curricula that are sensitive to the needs of rural health, Indian health, public health, and diverse and mobile populations. Participants may also explore curriculum and research topics that provide insight into the development of strategies that work to train public health care on the safety issues related to bioterrorism and disaster preparedness.

The system has the potential to train thousands of individuals around the nation. Examples include healthcare workers, public health personnel, law enforcement, fire, military, Border Patrol, emergency, volunteers such as Red Cross and any other individual requiring emergency training. Healthcare workers include medicine, nursing, allied health, dental, mental health, nutrition and physicians assistants.

In addition to designing a distance learning system, a system was developed to track a variety of activities and data on a longitudinal basis. The data currently being tracked include documentation of the training activities and their target audience, number of event participants, survey responses and response rates, and contact information. Some additional information developed and routinely collected for electronic web-based system include the number of web-site hits, survey data collected specifically for individuals taking courses on-line, and pre and post course assessments of learning objectives.

The course catalog 22 lists all the lesson modules with short descriptions of each. The user chooses a lesson from the catalog, takes a pre test and enrolls in the lesson. The enrollment process offers the option of taking the lesson for non-credit, continuing education credit, or (future) academic credit. A fee for access paid and tracked under the e-commerce function 32. In addition the user is able to purchase continuing education credits 42, but may be eligible for free credits that are established by the system administrator. For example, North Dakota residents may be given the option of free credits, whereas non-resident users must pay a credit fee. The interactive learning management system tracks users who complete lessons for credit and non credit.

The dissemination of education and training may be linked to a database via a number of communication links which include, but are not limited to, the internet, electronic mail network, wide area network, satellite, and wired and wireless telephone communication 50. The communications link is accessed by variety of display systems 60 that include stationary and mobile, portable, or hand held devices. Preferred embodiments of display systems 60 include personal computer, laptop computer, auto PC, personal digital (PDA), mobile digital assistance, pocket PC and like devices, cellular phones with video displays or any other system capable of displaying video images. The location of the portable or hand held device may also be linked to a GPS system to provide information to the user about an emergency event in a specific location where the user is or will be. The device may also be capable of displaying emergency events provided by an emergency broadcast system.

Recognizing that present and future health care practitioners are likely to be front-line participants in bioterrorist attacks and other disasters, the system assists individuals as well as state and local public care systems in their efforts to prepare for and identify threats, and to subsequently respond to the consequences of actual medical emergencies in immediate and appropriate ways.

In a representative embodiment, the system's distance learning consists of the following modules and lessons: Disaster Response, Part I, Core Concepts of Chemical Agents, Core Concepts of Bioemergencies, Core Concepts of Nuclear/Radiological Emergencies, Explosive and Traumatic Injuries, Psychological Effects of Trauma; Legal and Ethical Issues, and advanced lessons on Smallpox, Tularemia, Botulism, Plague, and Emerging Infectious Diseases, Advanced discipline-specific lessons on Chemical Agents (Nerve Agents, Blister Agents, Inhaled Toxins, Vesicants, Cyanide, Riot Control Agents) and complete modules on National Incident Command System, the Role of Public Health in Disaster Response, Psychological First Aid, and Cultural Competence in Disaster Mental Health.

Additional components that can be added to the Core Concepts lessons include specific information about meeting the acute care needs of special and vulnerable populations, including geriatrics, pediatrics, and under-represented and culturally diverse populations.

The system may deliver periodic training, such as “Train the Trainer” program to sustain its training efforts. The workshops include presentation of the web-based lessons on the core concepts of bioterrorism, how to conduct small group exercises, and the sharing of lesson plans/training activities that trainers can utilize in presenting future classes. Facilitator sessions includes presentations of specific lessons that trainers can access and use after attending the specific training sessions in person.

The train the trainer program provides the opportunity for individuals in public health agencies, hospitals, community health centers, local emergency medical centers, fire departments and other health agencies to deliver the system's educational programs to the emergency preparedness providers in specific regions.

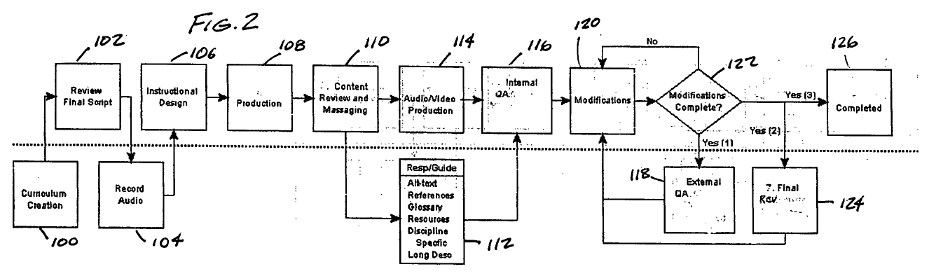

As shown in FIG. 2, a process diagram for lesson development, each emergency preparedness lesson to completion. After idea conception for a lesson the steps included in lesson development can be selected from a group of steps such as curriculum creation (step 100); scripting and instructional design (steps 102, 104, 106) resulting in production of lesson (step 108); content review and revisions (steps 110, 112); integration of visual and audio material (step 114); internal quality assurance (step 116); external quality assurance (steps 118, 120, 122); and a final review (step 124); resulting in a completed lesson (step 126). The lesson final format may be, for example, html format for distance learning or in power point format for live presentation that supplement electronic learning.

The curriculum content expert writes a first draft of a lesson, then the lesson is reviewed by a team of editors until it is approved as a final script. A team of instructional designers then animates the lesson with interactive graphics, illustrations, tables and/or photographs that serve as exhibits. This is referred to as the production phase. During the production phase, the content is reviewed and massaged and purposed for a web-based interface. At this point, audio/video production begins, while the curriculum writing team writes glossary terms, cites resources, adds discipline-specific references to the lesson, and writes the long descriptions of all visual effects so that the lesson is 508 compliant for the handicapped user. The lesson then goes through an internal quality assurance test by the instructional design team, modifications are made if necessary, and the lesson is then returned to the curriculum writing team for a final external quality assurance test. The final review is completed by the content expert who authored the lesson. At this point, the lesson is considered complete and ready to go live on the web.

Each lesson is developed with a unique user flow and a training interface that supports online instructional training techniques proven to increase learner gained knowledge and retention. The lessons are SCORM conformant—all training is approved and tested by the ADL Co-Lab. The lessons all have a high level 508 compliance and are measured and approved with Bobby eGOV compliance and tested in top screen readers for correct learning flow for impaired learners. The bottom of each lesson screen contains a cognitive learning self check to ensure that the learner retains page knowledge.

High impact Interactive Learning Objects (ILO) with full 508 learning descriptions for impaired learners are included in each lesson to increase learner interaction and retention. The lessons are all professionally narrated and each screen has an audible learning control with full transcripts. There is a full feature glossary for all medical and scientific terms. There are learner discipline specific learning options throughout training, such as “nursing pathways” that have information directed toward the nursing profession.

The curricula/courses are reviewed by experts who assure standardization in relation to the December 2004 Department of Homeland Security (DHS) National Response Plan, specifically the HSPD-5: National Incident Management System (NIMS), HSPD-8: National Domestic All-Hazards Preparedness Goal, and HSPD-10: Comprehensive Framework for the Nation=s Biodefense. The system drills and exercises are coordinated, wherever possible, with DHS drills/exercises or with state or local preparedness drills or exercises and as such are compliant with the National Incident Command System.

The curriculum involving the disciplines of medicine, nursing, clinical laboratory science, allied health, mental health, physician assistants, dental, pharmacy, EMS and others including volunteer responders includes a broad integrated, multi-tiered array of learning opportunities. Participants from other disciplines are also encouraged to use the system in accordance with the goals of the project.

### EXAMPLE 1

### BORDERS Interactive Learning Management System

The BORDERS Alert and Ready system, www.bordersalertandready, has been developed the provides: full CE/CME credit tracking—and real-time CE/CME certificate printing when training completed; E-commerce and scholarship support allowing differentiation between scholarship and non-scholarship paid training application; pre and post tests to measure training effectiveness per training topic. Other BORDERS features contained Section 508 Compliant LMS to allow for easy navigation for impaired learners, lesson book marking at topic and page level; real-time data mining for easy reporting and learner reports; all standard CMS features built in. surveys, website Content Management, newsletters and email marketing features.

BORDERS was developed to be SCORM 1.3 supported. LMS 20 allows for easy implementation of SCORM conformant training.

The user goes through the following steps to complete a BORDERS on-line lesson that include “enter the BORDERS URL”; “login”; click on “My Training”; select a lesson from the catalog; complete the required reading that informs the user of copyright; terms of use; complete the pre test; complete the lesson training; complete the post test; if answers are incorrect, user is directed back to the post test to repeat until all answers are correct; and complete the lesson evaluation. Upon completion a certificate is printed or Continuing Education certificate is provided

Nearly 8,000 individuals have participated in the distance learning training via the system's web site and/or have enrolled in didactic and clinical field experiences in urban and rural areas of North Dakota and Minnesota. Participants engage in training events in areas on or near rural Native American reservations, military bases, an international border, agricultural areas and urban centers. These experiences are based on a patient-centered care learning approach, and help participants understand the need for a coordinated, multidisciplinary response to terrorist events and disasters, and familiarize them with appropriate local, regional, state, national and international resources. Although the present invention is described above in terms of North Dakota and Minnesota, in other embodiments the invention can be used in any state or nation.

### EXAMPLE 2

### Supplemental Live Training

As a representative embodiment, a two-day multidisciplinary course titled “Core Concepts of Disasters and Terrorist Events: Medical Issues and Response” was presented in communities across North Dakota and Minnesota. Group learning at the community-based on-site trainings has been designed to follow the basic steps as set forth in the national domestic all-hazards preparedness standards. Case studies provided the context for a multidisciplinary approach to learning about bioterrorism and disaster integrated with issues such as community and preventative medicine, as well as the essentials of culturally competent care to individuals and specific vulnerable populations. Small group learning sessions are supported by community experiences, demonstrations and concept-anchoring lectures throughout the training to reinforce key concepts or skills. Whenever possible, actual representatives of the community's preparedness and response network present demonstrations and/or case wrap-up sessions.

The second day of Core Concepts of Disasters and Terrorist Events: Medical Issues and Response culminates with a National Incident Command System “top-off” style drill that simulates a mass casualty and requires the participants to respond as a multidisciplinary team and includes triage, transportation, communications, reporting, donning and doffing of personal protective equipment, and decontamination drills.

The post-assessment was customized to measure competencies and set approval pass rate for participants to receive credit for the training which provided Certificates for Continuing Eduation and similar certificates required by an organization to meet practioner qualifications and requirements by approved bodies.

Although the present invention has been described with reference to preferred embodiments, workers skilled in the art will recognize that changes may be made in form and detail without departing from the spirit and scope of the invention.

1. A system for teaching healthcare and public health personnel to prepare for or respond to an act of terrorism or natural mass casualty disasters, the system comprising:
a database accessible to the healthcare and public health personnel, the database including at least one module that provides at least one lesson related to terrorism or natural mass casualty disasters;
a communication link for accessing the database; and
a display system for connection to the database through the communication link.

2. The system of claim 1, wherein the act of terrorism or natural mass casualty disaster is a biological, chemical, radioactive or explosive agent.

3. The system of claim 1 wherein the communication link is one of Internet, electronic mail network, wide area network, and wired and wireless telephone communication.

4. The system of claim 1 wherein said databook provides detailed medical or clinical information on a diagnosis, progression or treatment of individuals affected by the act of terrorism or natural mass casualty disaster.

5. The system of claim 1 wherein the module further comprises:
an assessment of knowledge before and after accessing the lesson; and
live on-site training at a site or pre-recorded on-site training stored on the database and accessed via the communication link.

6. The system of claim 1 and further comprising:
a means for alerting healthcare and public health personnel of an act of bioterrorism or potential mass casualty disaster.

7. A method for educating and training individuals on how to efficiently react, contain and respond to a natural or a man-made disaster, the method comprising:
educating the individuals, over a wide range of topics, through a web-based distance learning instructional program;
testing the individuals to ascertain their understanding of each topic; and
training the individuals through a community-oriented disaster scenario.

8. The method of claim 7, wherein the natural or man-made disaster is a biological, chemical, radioactive or explosive agent.

9. The method of claim 7, wherein said man-made disaster is an act of bioterrorism.

10. A method for educating and training individuals on how to effectively diagnose or treat a natural or a man-made disaster, the method comprising:
educating the individuals on the clinical diagnosis, progression or medical treatment of a population affected by the disaster through a web-based distance learning instructional program;
training the individuals through a community-oriented disaster scenario; and
testing the individuals to ascertain their understanding of each topic.

11. The method of claim 10, further comprising;
certifying the individuals after passing the test.

12. The method of claim 11, further comprising;
recertifying the individuals on a reoccurring basis.

13. The method of claim 10, wherein the natural or man-made disaster is a biological, chemical, radioactive or explosive agent.

14. The method of claim 10, wherein said man-made disaster is an act of bioterrorism.
